(19) United States
(12) Patent Application Publication
(10) Pub. No.: US 2004/0111244 A1
(43) Pub. Date: Jun. 10, 2004

(54) Algorithm for fast determination of suspicious cites inside interconnect segments with the high probability of nucleation electromigration-induced voids

(76) Inventors: Valeriy Sukharev, Cupertino, CA (US); Ratan Choudhury, Milpitas, CA (US); Chong Park, Cupertino, CA (US)

Correspondence Address: LSI LOGIC CORPORATION, 1621 BARBER LANE, MS: D-106 LEGAL, MILPITAS, CA, 95035, US

(21) Appl. No.: 10/310,185

(22) Filed: Dec. 4, 2002

(51) Int. Cl. G06G 7/48

(52) U.S. Cl. 703/6

(57) ABSTRACT

The invention provides an algorithm for a methodology for interconnect design optimization by means of electromigration simulation. The algorithm provides for the capability to explore the effect of metal feature geometry, such as line width and height, a diffusion barrier (liner) material properties and thickness, via slop and corner rounding, and interconnect architecture (number of layers, feature density) on the probability of electromigration-induced and stressmigration-induced void nucleation. Implementation of all major driving forces for atom migration allows to predict a complete map of positions inside segments where void nucleation can be expected.

### BACKGROUND OF THE INVENTION

The present invention relates to a methodology for interconnect design optimization by means of electromigration simulation.

Implementation of copper and low-K materials as major components of interconnect structures has resulted in the necessity to create new current design rules to ensure chip immunity to electromigration-induced failures. This practical demand causes an enormous interest in understanding the fundamental reliability properties of a copper dual-damascene metallization.

Physically based models and simulations can be considered as powerful tools that can help to address this demand. Implementation of reliability simulation capabilities at the design rules generation step can help to avoid unnecessary conservative approaches which reduce possible chip performance.

Currently, there are no available simulation tools capable to solve this problem. The experimental approach has a statistical nature that makes it very difficult to separate the roles of different parameters on the void dynamics and the mean time to failure (MTTF). The experimental approach is also disadvantageous because the experimental approach has a statistical nature that makes it very difficult to separate roles of different parameters on the void dynamics and the mean time to failure (MTTF). The optimization procedure is based on the method of trials and mistakes and results usually lead to the conservative conclusions.

Therefore, an improved methodology for interconnect design optimization by means of electromigration simulation is needed. The present invention provides such a methodology for interconnect design optimization by means of electromigration simulation. Features and advantages of the present invention will become apparent upon a reading of the attached specification, in combination with a study of the drawings.

### OBJECTS AND SUMMARY OF THE INVENTION

A primary object of the invention is to provide an algorithm for a methodology for interconnect design optimization by means of electromigration simulation.

Another primary object of the invention is to provide a simulation capable for interconnect architecture and geometry optimization to reduce the probability of electromigration-induced failure.

An object of the invention is to provide reliable simulation capabilities at the design rules generation step in order to help avoid unnecessary conservative approaches which reduce possible chip performance.

Another object of the invention is to provide the capability to explore the effect of metal feature geometry, such as line width and height, a diffusion barrier (liner) material properties and thickness, via slop and corner rounding, and interconnect architecture (number of layers, feature density) on the probability of electromigration-induced and stressmigration-induced void nucleation.

Yet another object of the invention is to provide new current design rules to ensure chip immunity to electromigration-induced failures.

Briefly, and in accordance with the foregoing, the present invention provides an algorithm for a methodology for interconnect design optimization by means of electromigration simulation. The algorithm provides for the capability to explore the effect of metal feature geometry, such as line width and height, a diffusion barrier (liner) material properties and thickness, via slop and corner rounding, and interconnect architecture (number of layers, feature density) on the probability of electromigration-induced and stressmigration-induced void nucleation. Implementation of all major driving forces for atom migration allows to predict a complete map of positions inside segments where void nucleation can be expected.

### BRIEF DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a flow chart illustrating an algorithm for a methodology for interconnect design optimization by means of electromigration simulation.

### DETAILED DESCRIPTION OF THE ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated and described herein.

Implementation of copper and low-K materials as major components of interconnect structures has resulted in the necessity to create new current design rules to ensure chip immunity to electromigration-induced failures. This practical demand causes an enormous interest in understanding the fundamental reliability properties of a copper dual-damascene metallization. Physically based models and simulations can be considered as powerful tools that can help to address this demand. Implementation of reliability simulation capabilities at the design rules generation step can help to avoid unnecessary conservative approaches which reduce possible chip performance. To be able to reach this target, a comprehensive simulation model of metal migration-induced failure should be employed.

In the general case, a three-dimensional modeling should be applied. Three-dimensional modeling involves nonlinear interaction between local and global (cooperative) effects involved in metal atom migration mechanisms. This is especially true for copper metallization characterized by a much lower critical stress for void nucleation than aluminum.

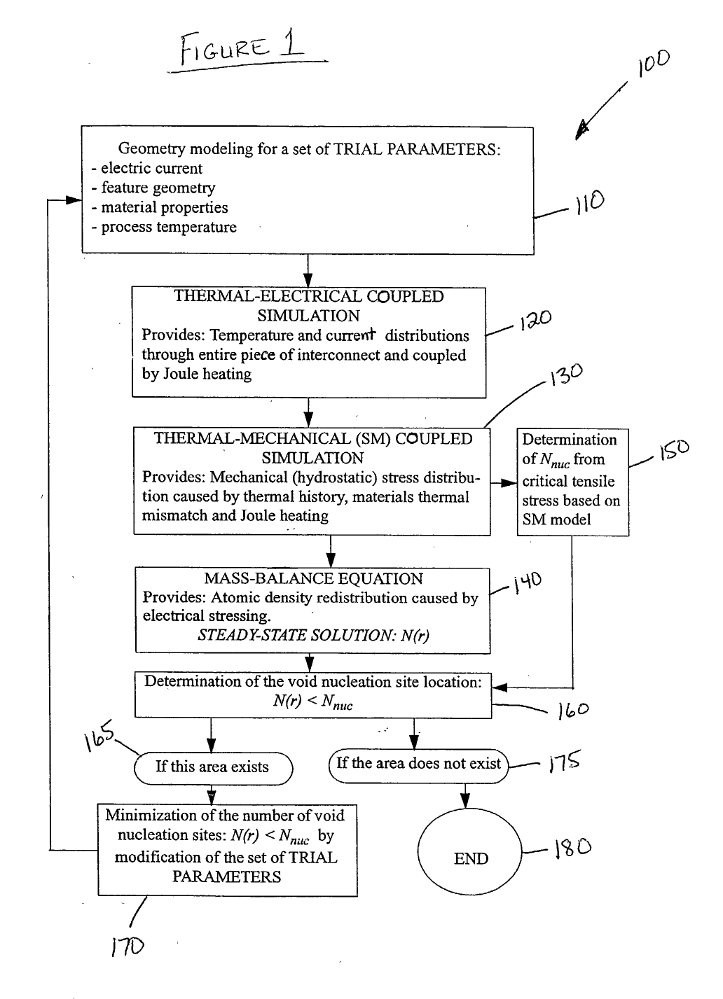

Algorithm 100, illustrated in the flow chart of FIG. 1, allows for the prediction of a probability distribution of void nucleation inside interconnect segment.

The method for performing the algorithm 100 includes the following steps:

1) Initially providing geometry modeling for a set of trial parameters 110. The trial parameters include, but are not limited to, electric current, feature geometry, material properties and process temperature;

2) After step (1), performing a thermal-electrical coupled simulation 120. The thermal-electrical coupled simulation provides temperature and current distributions through entire piece of interconnect and coupled by Joule heating;

3) After step (2), performing a thermal-mechanical coupled simulation 130. The thermal-mechanical coupled simulation provides mechanical (hydrostatic) stress distribution caused by thermal history, materials thermal mismatch and Joule heating;

4) After step (3), determining a mass-balance equation 140. The mass-balance equation provides atomic density redistribution caused by electrical stressing with a steady-state solution being defined as N(r);

5) After step (3), determining N_{nuc} 150. N_{nuc} is determined from critical tensile stress based on the thermal-mechanical coupled simulation performed in step (3);

6) After steps (4) and (5), determining the void nucleation site location 160 with N(r)<N_{nuc};

7) After step (6), if N(r) is less than Nₙ, such that this area exists 165, minimizing the number of void nucleations sites N(r)<N_{nuc} by modifying the set of trial parameters 170 and returning to step (1) 110; and

8) After step (6) if N(r) is greater than or equal to N_{nuc}, such that the area does not exist 175, ending the method 180.

Thus, the algorithm 100 provides a three-dimensional, fully-linked electromigration model. The algorithm 100 takes into consideration all known atom migration causes, namely, electron induced momentum transfer, time-dependent stress gradient, thermal diffusion, and concentration gradient induced migration. Implementation of the vacancy related diffusion mechanism has provided the capability to accurately implement a stress dependent atom diffusivity which was different in different regions of the interconnect segment.

A general character of the developed model has allowed for the investigation of the effect of current direction on failure localization. A coupling of the electromagnetics, heat transfer, structural mechanics and atom migration models, based on direct solution of the system of partial differential equations in the FEM environment, has allowed for the simulated stress-induced void nucleation in different interconnect segments. The model also allows for the demonstration of the role of different atom migration driving forces in failure development. Obtained simulation results have been found to fit well to the available experimental data regarding the location of void formation and growth.

Thus, the algorithm 100 provides the capability to explore the effect of metal feature geometry, such as line width and height, a diffusion barrier (liner) material properties and thickness, via slop and corner rounding, and interconnect architecture (number of layers, feature density) on the probability of electromigration-induced and stressmigration-induced void nucleation. Implementation of all major driving forces for atom migration allows to predict a complete map of positions inside segments where void nucleation can be expected.

The algorithm 100 can alternatively be used to solve a transient, three-dimensional, fully-linked electromigration model. A complicated geometry of the standard copper dual-damascene based interconnect segment requires implementation of parallel computing technique for solution of a transient problem. This makes such kind of predictions more time and resources expensive.

While a preferred embodiment of the present invention is shown and described, it is envisioned that those skilled in the art may devise various modifications of the present invention without departing from the spirit and scope of the appended claims.

The invention is claimed as follows:

1. A method of predicting a probability distribution of void nucleation inside interconnnect segment, said method comprising the steps of:
a) providing geometry modeling for a set of trial parameters;
b) performing a thermal-electrical coupled simulation;
c) performing a thermal-mechanical coupled simulation;
d) determining a mass-balance equation N(r);
e) determining N_{nuc} from critical tensile stress based on said thermal-mechanical coupled simulation;
f) comparing N(r) to N_{nuc};
g) if N(r) is less than N_{nuc} minimizing a number of void nucleation sites by modifying said set of trial parameters and returning to step (a); and
h) if N(r) is greater than or equal to N_{nuc}, finishing said method.

2. A method as defined in claim 1, wherein said set of trial parameters include electric current, feature geometry, material properties and process temperature.

3. A method as defined in claim 1, wherein said thermal-electrical coupled simulation provides temperature and current distributions through entire piece of interconnect and coupled by Joule heating.

4. A method as defined in claim 1, wherein said thermal-mechanical coupled simulation provides mechanical stress distribution caused by thermal history, materials thermal mismatch and Joule heating.

5. A method as defined in claim 1, wherein said mass-balance equation provides atomic density redistribution caused by electrical stressing.

6. A method as defined in claim 1, wherein N(r) is a steady-state solution.

7. A method as defined in claim 1, wherein steps (d) and (e) are performed simultaneously, prior to step (f) being performed.

8. A method as defined in claim 1, wherein said method provides a three-dimensional, fully-linked electromigration model.
